(19) United States
(12) Patent Application Publication
(10) Pub. No.: US 2014/0246135 A1
(43) Pub. Date: Sep. 4, 2014

(54) IMPROVEMENTS TO TIRES

(71) Applicant: STARCO DML LTD, Crewe, Cheshire (GB)

(72) Inventor: Mike Andrews, Crewe (GB)

(21) Appl. No.: 14/353,187

(22) PCT Filed: Oct. 24, 2012
(86) PCT No.: PCT/GB12/52638

§ 371 Date: Apr. 21, 2014

(30) Foreign Application Priority Data
Oct. 24, 2011 (GB) GB 1118302.7

(51) Int. Cl. B60C 7/10; B29D 30/02

(52) U.S. Cl. CPC B60C 7/10; B29D 30/02
USPC 152/310; 264/255

(57) ABSTRACT

A tyre (2) suitable for use with a forklift truck which includes a first outer layer (4) of polymeric material and one or more layers of polymeric material substantially under the first layer (4). The outermost layer (4) is substantially more flexible than the one or more layers underneath the same.

The present invention relates to tyres and wheels, as well as methods of producing the same.

Although the present description refers to tyres and wheels for forklift trucks, the person skilled in the art will appreciate that the present invention can be used on other vehicles and load bearing equipment and is not limited exclusively to forklift trucks.

Conventional forklift truck tyres are typically made of one piece of rubber. These tyres are either pressed into single-piece wheels (wheels with a single hub) or held between the dual hubs of two-piece wheels. Both types of conventional wheels have centrally located well or recess formed around the circumference of the hub. Conventional tyres have a sizable protrusion which is inserted into the well to hold the tyre in place. The protrusion increases the overall weight of the tyre and makes changing the tyre more difficult.

Furthermore, due to the tyre being constructed from a single piece of rubber, the user is unable to ascertain when the tyre tread has worn away to such a degree that the tyre should be replaced. As such, forklift truck tyres are replaced at set time intervals whether the tyre needs replacing or not. This results in an unnecessary replacement of tyres and increased costs for the user.

It is therefore an aim of the present invention to provide an improved tyre, and wheel incorporating said tyre, which addresses the abovementioned problems.

It is a further aim of the present invention to provide a forklift truck tyre which can be located on conventional wheels and/or custom manufactured wheels, said tyre being lightweight, non-marking and has improved wear properties.

It is yet a further aim of the present invention to provide a method of producing an improved forklift truck tyre.

In a first aspect of the invention there is provided a tyre, said tyre including a first outer layer of polymeric material and one or more layers of polymeric material substantially under the first layer wherein the outermost layer is substantially more flexible than the one or more layers underneath the same.

In one embodiment of the invention there is provided a tyre, said tyre including two or more layers of polymeric material wherein the outermost layer is substantially more flexible, elastic and/or pliable than one or more of the inner layers.

Typically one or more of the inner layers is any one or any combination of denser, firmer and/or more rigid polymer material than the first outermost layer.

Typically the outermost layer is the tyre tread layer. Further typically the outermost layer includes a tread and is more flexible than the inner layer underneath the same, in order to improve grip on the surface on which the tyre travels.

Preferably the tyre comprises two layers wherein the inner layer is more rigid than the outer.

In one embodiment the more rigid layer forms a ring under the outer layer. Typically the ring has a cross sectional area which is less than the cross sectional area of the outermost layer, when viewed along the latitudinal or circumferential axis.

Preferably the polymer in at least one of the polymeric layers is substantially polyurethane.

In one embodiment the polyurethane is produced using an isocyanate compound. Typically the isocyanate is an aromatic isocyanate. In one embodiment the aromatic isocyanate includes diphenylmethane diisocyanate (MDI).

The relative amounts of the three MDI isomers (4,4′-MDI, 2,4′-MDI, and 2,2′-MDI) can be selected to change physical properties of the layers, i.e. selecting the isomer amounts/ratios for a more rigid layer.

In one embodiment the polyurethane is manufactured using a polyol. Typically the polyurethane is manufactured from an aromatic isocyanate mixed with a polyol.

Typically the polyol is a polyester and/or a polyether. Preferably the polyol used in the polymerisation of the outermost layer is a polyester.

Further typically the molecular weight and/or the functional groups of the polyol polymer can be selected to change the physical properties of the polyurethane.

In one embodiment the polymeric layers are crosslinked together. Typically the outermost layer is crosslinked to the layer underneath the same.

In one embodiment at least the outermost layer of the tyre is a natural colour, in as much that no pigments and/or dye containing compounds are added to the same. This produces a tyre in which at least the outermost layer is non-marking.

In one embodiment at least one of the layers is of a different appearance to the layer adjacent to the same. Typically the different appearance is due to the layers being different colours. Further typically any one or any combination of pigments, dyes and/or colorants are added to the polymeric mixture to colour one or more layers.

In one embodiment at least one of the inner layers underneath the outermost layer is of a different colour and/or appearance.

Typically when the outermost or tread layer is worn away the different colour and/or appearance of the inner layer begins to show through. Thus an indication is given as to when the tyre needs changing.

In one embodiment the outermost layer is substantially opaque. Thus, only when the tread is worn away does the inner layer become visible.

In an alternative embodiment the outermost layer is any one or any combination of partially opaque, substantially semi-transparent and/or transparent polymer material. Thus, the layer underneath the tread becomes increasingly visible as the tread wears away.

In a second embodiment of the invention there is provided a method of making a tyre including at least two polymeric layers, said method including the steps of;
spinning and/or rotating a mould about an axis;
introducing a first material into the mould where said first material can be polymerised into the outermost polymeric layer;
introducing at least a second material into the mould where said second material can be polymerised into an inner polymeric layer; and
polymerising said first and at least second materials to form two or more layers

wherein the at least second layer is more rigid than the outermost layer.

In one embodiment the mould includes or is substantially constructed from steel and/or stainless steel. Typically the steel has a higher specific heat capacity that conventional aluminium moulds.

Typically the mould is heated to a temperature substantially equal to or above 80° C. Further typically the temperature of the mould in not in excess of 120° C. In one embodiment the mould is heated to temperature 90° C.-110° C. Preferably the temperature of the mould is substantially 100° C.

In one embodiment the first material gels and/or forms a gel before the second material is added.

In one embodiment the first material is polymerised or at least partially cured before the second material is introduced.

In a further embodiment the first material is only partially polymerised or cured before the second material is introduced.

In one embodiment the two or more layers are crosslinked together.

Typically the second polymer material is introduced before the first material is fully cured, thus effecting improving the cross-linking between the two materials and/or layers.

In a third aspect of the invention there is provided a wheel suitable for use with a vehicle such as a forklift truck or similar, said wheel including a tyre comprising two or more layers of polymeric material wherein the outermost layer is substantially more flexible than one or more of the inner layers.

In one embodiment the tyre includes one or more recesses located substantially at the edge of the same. Typically the wheel rim or hub includes one or more protrusions which can engage with the recesses to improve the tyre fit and prevent slippage.

In a forth aspect of the invention there is provided a tyre suitable for use with a fork lift truck, said tyre including one or more recesses located substantially at the edge of the same wherein said recesses can engage with the wheel rim and/or hub to which the tyre is attached in use.

Typically the recesses prevent the tyre from slipping on the rim and/or hub.

Specific embodiments of the invention are now described with reference to the following figures, wherein;

FIG. 1 shows a forklift truck wheel in accordance with one aspect of the invention;

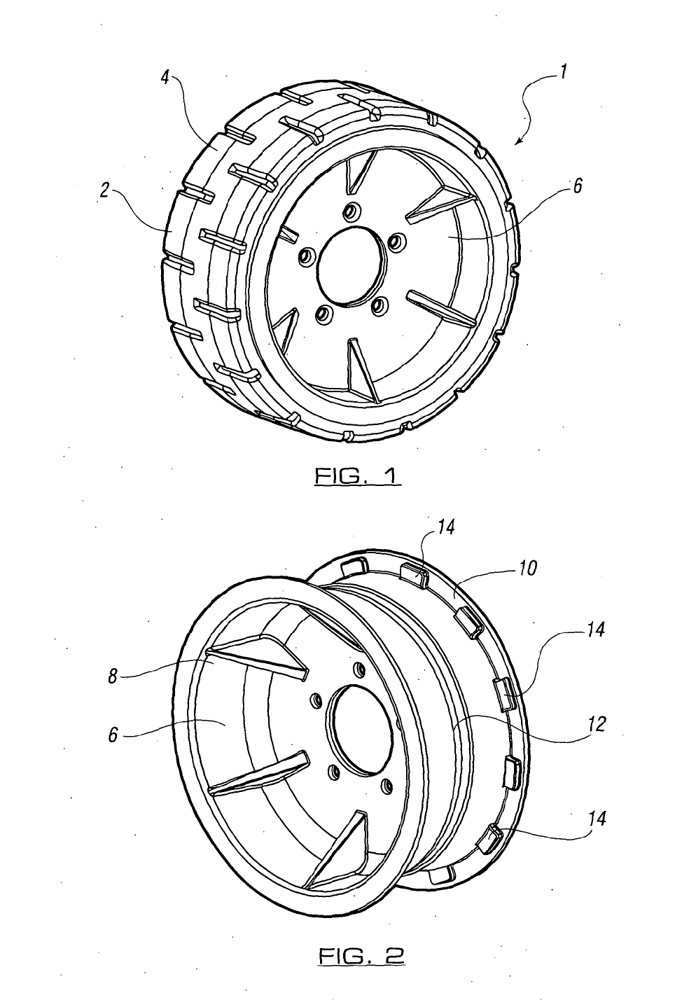

FIG. 2 shows a forklift truck wheel hub in accordance with one embodiment of the invention;

FIG. 3 shows a tyre in accordance with one embodiment of the invention; and

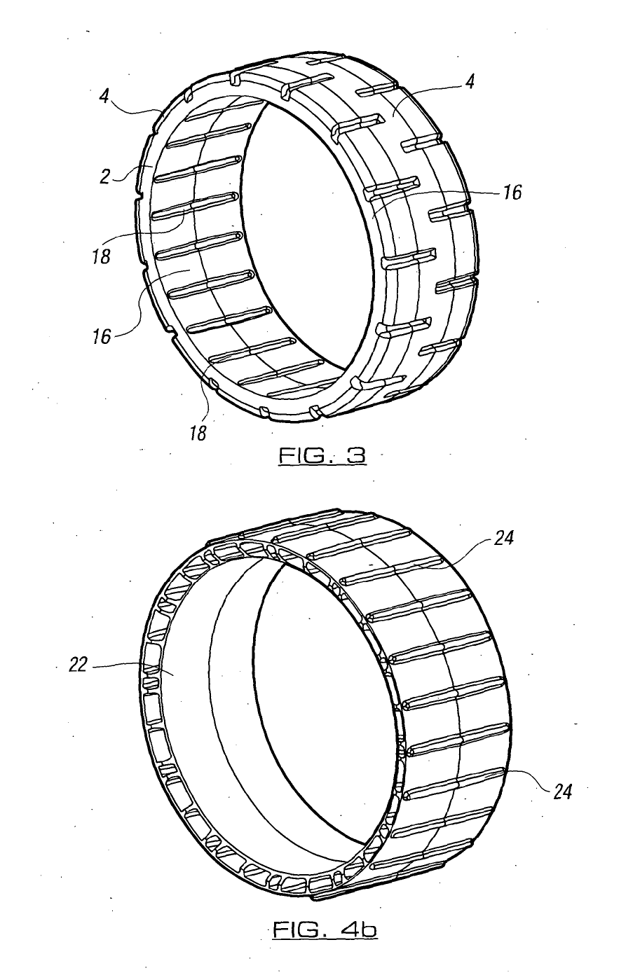

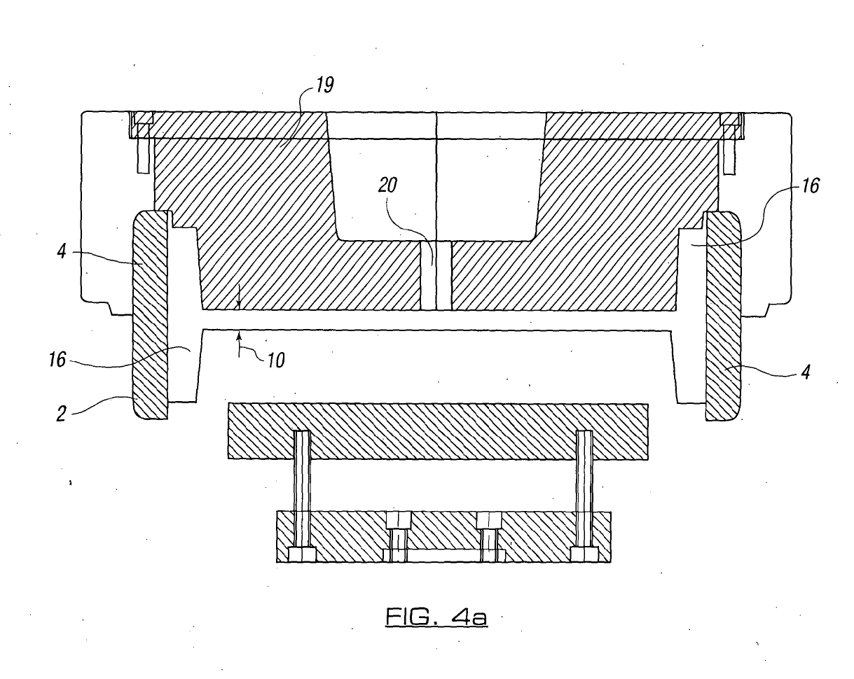

FIG. 4a shows a cross sectional view through the tyre and the mould; and

FIG. 4b blank used in the production of tyres in accordance with the invention.

The present invention discloses a new tyre which is suitable for use with relatively slow moving, load-carrying vehicles such as forklift trucks and the like. The tyre has at two or more layers, wherein the outermost or ‘tread’ layer is more flexible and less rigid than the layer underneath. The more rigid layer underneath allows the tyre to be held in position and function without requiring a large amount of material to be situated in the recess/well in the wheel or hub. As a result the tyre of the present invention is lighter and less expensive than conventional tyres and wheels.

Turning firstly to FIG. 1 where there is shown a forklift truck wheel 1 including a tyre 2 which comprises two layers of polyurethane. The outer tread layer 4 is constructed of polyurethane which is more elastic and flexible than the layer underneath. Conventional tyres have a relatively large amount of material located centrally around the inside of the tyre which sits in a recess in the wheel hub 6. This material holds the tyre in position when in use but increases the weight of the same. As such, changing conventional tyres is difficult. The new tyre 2 shown in FIG. 1 requires less material to manufacture the same and has a lower profile. As a result the new tyre 2 is lighter and easier to change to the extent that changing can be performed without the hydraulic press usually required.

In the example shown in FIG. 1 the inner layer 4 underneath the outer layer 2 is coloured. This provides a further advantage because as the tread of the outer layer wears away through use, the coloured layer underneath is exposed. Thus the layers provide an indication to the operator that the tyre needs changing, improving safety and saving on unnecessary tyre changes.

FIG. 2 shows a wheel hub 6 to which the new tyre can be fitted. This particular hub is a two-piece hub which is assembled from two rims 8, 10. When the rims are attached together the hub 6 includes a recess 12 located centrally around the circumference of the hub. The recess on conventional fork-lift wheel hubs can be relatively deep in order to secure the tyre to the same. The recess 12 shown here is much shallower in comparison very little or none of the tyre is required to sit in the recess in order to secure the tyre to the hub 6.

In addition, the hub 6 includes a number of protrusions or projections 14 which increases the frictional force between the hub 6 and the tyre, thus helping to prevent slippage between the tyre and the hub.

Turning now to FIG. 3 where there is shown the tyre 2 free from the wheel hub. The outer layer 4 is constructed from a polyurethane which is substantially less rigid, less firm and more flexible than the polyurethane layer underneath 16. This composition ensures than the vehicle to which the wheel is attached has a tyre where the tread is soft enough to provide grip to the surface on which it is travelling, and the layer of the tyre underneath the tread is hard enough to secure the same to the wheel hub. It can be seen that the under layer 16 has a number of recesses or troughs 18 formed in the same. These troughs are formed by the mould in which the tyre is formed and help to reduce the overall weight of the tyre without compromising the strength by which the tyre is fixed to the wheel.

FIG. 4a shows a cross sectional view through the spin moulding apparatus 19 in which the tyre 2 is formed. Typically the mould is spun and the liquid polymer injected though the central feed bore 20. The polymer making up the outer tread layer 4 of the tyre is introduced first. The precursor may be a liquid precursor until cured and/or heat may be applied to ensure the polymer mixture is liquid when introduced. Subsequently the polymer for the second more rigid layer under the tread is introduced, which too may be a liquid precursor and/or molten polymer until cured. A cross-linking agent may also be introduced at this point to ensure the inner and outer polymer layers are strongly bonded together.

The person skilled in the art will appreciate that tread patterns including recesses and ridges may be formed in the tyre 2 by shaping the mould. FIG. 4b shows a blank 22 for the mould 19 which includes a number of ridges or ribs 24 which form the corresponding recesses or troughs 18 in the inner layer 16 of the tyre 2 as shown in FIG. 3.

1: A tire including a first outer layer of polymeric material and one or more layers of polymeric material substantially under the first layer wherein the outermost layer is substantially more flexible than the one or more layers underneath the same.

2: A tire according to claim I wherein the one or more layers underneath the outermost layer are inner layers and comprise any one or any combination of denser, firmer and/or more rigid polymer material than the first outermost layer.

3: A tire according to claim 1 wherein the outermost layer includes a tread.

4: A tire according to claim 1 wherein the tire comprises two layers, the inner layer being more rigid than the outer.

5: A tire according to claim 4 wherein the inner layer forms a ring under the outer layer, said inner layer having a cross sectional area smaller than that of the outer layer.

6: A tire according to claim 1 wherein at least one of the layers comprises a polyurethane compound.

7: A tire according to claim 6 wherein the polyurethane is produced using an isocyanate and/or a polyol.

8: A tire according to claim 7 wherein the isocyanate is an aromatic isocyanate and the polyol is a polyester and/or a polyether compound.

9: A tire according to claim 8 wherein the isocyanate includes one or more isomers of diphenylmethane diisocyanate (MDI).

10: A tire according to claim 1 wherein the polymer layers are crosslinked together.

11: A tire according to claim 1 wherein the outermost layer is a substantially non-marking natural color with no pigments added to the same.

12: A tire according to claim 1 wherein the layers are different colors.

13: A tire according to claim 12 wherein the layer underneath the outermost layer is a different color to the same.

14: A tire according to claim 13 wherein the outermost layer is either substantially opaque or at least partially transparent.

15: A method of making a tire including at least two polymeric layers, said method including the steps of;
spinning and/or rotating a mold about an axis;
introducing a first material into the mold where said first material can be polymerized into the outermost polymeric layer;
introducing at least a second material into the mold where said second material can be polymerized into an inner polymeric layer; and
polymerizing said first and at least second materials to form two or more layers wherein the at least second layer is more rigid than the outermost layer.

16: A method according to claim 15 wherein the mold includes or is substantially constructed from steel and/or stainless steel.

17: A method according to claim 15 wherein the mold is heated to temperature 90° C.-110° C.

18: A method according to claim 15 wherein the first material is polymerized or at least partially cured before the second material is introduced.

19: A method according to claim 15 wherein the second polymer material is introduced before the first material is fully cured, thus effecting improving the cross-linking between the two materials and/or layers.

20: A wheel suitable for use with a forklift truck or similar, said wheel including a tire comprising two or more layers of polymeric material wherein the outermost layer is substantially more flexible than one or more of the inner layers.
